(19) United States
(12) Patent Application Publication
(10) Pub. No.: US 2016/0332387 A1
(43) Pub. Date: Nov. 17, 2016

(54) A DEVICE AND METHOD FOR REMOVING 3D PRINT MATERIAL FROM BUILD PLATES OF 3D PRINTERS

(71) Applicant: STOCKLYN VENTURE, LLC, Brooklyn, NY (US)

(72) Inventors: Viktor JONDAL, Taby (SE); Peter RAGONETTI, Brooklyn, NY (US)

(21) Appl. No.: 15/110,367

(22) PCT Filed: Jan. 28, 2015
(86) PCT No.: PCT/US15/13219

§ 371 Date: Jul. 7, 2016

Related U.S. Application Data
(60) Provisional application No. 61/933,117, filed on Jan. 29, 2014.

(51) Int. Cl. B29C 67/00; B33Y 40/00; B33Y 30/00; B33Y 10/00

(52) U.S. Cl. CPC B29C 67/0092; B33Y 10/00; B33Y 40/00; B33Y 30/00

(57) ABSTRACT

A device and method for removing 3D prints from the build plate of a 3D printer comprising a sheet of flexible material sized and shaped to receive 3D print material and to fit atop the build plate of the 3D printer. The device and method of the present invention allows 3D prints to be removed from the build plate without damaging the prints or the build plate

### CROSS-REFERENCE TO RELATED APPLICATIONS

This application claims priority pursuant to 35 U.S.C. 119(e) to co-pending U.S. Provisional Patent Application, Ser. No. 61/933,117, filed Jan. 29, 2014, the entire disclosure of which is incorporated herein by reference.

### FIELD OF THE INVENTION

The present invention relates to a method and device for removing print material from build plates for three dimensional (“3D”) printing systems and, more particularly, to the use of flexible material to cover or replace build plates for 3D printers.

### BACKGROUND OF THE INVENTION

Typically, 3D printing, also known as additive manufacturing, involves depositing print material into sequential layers onto build plates until the desired 3D print is formed. The print material will typically bond onto the surface of the build plate. Once the printing process is complete, the bond between the print material and the build plate will need to be broken for the printed object to be removed from the build plate.

The bond between the print material and the surface of the build plate can make it difficult to remove the 3D print from the build plate following completion of the print process. To remove print material from the build plate, a user may be required to employ hand tools such as a scraper, or other means, to separate the print material from the build plate, which can lead to damage to the 3D print, the surface of the build plate and/or the user. In addition, because build plates are typically reused, it is desirable to ensure that all print material is removed from a build plate before beginning a new printing process. In some instances, such removal can be tedious and time consuming as well as potentially harmful to the build plate.

Accordingly, there is a need for a method and device that allows for the easy and safe removal of 3D prints from a build plate.

### SUMMARY OF INVENTION

The following summary is provided to facilitate an understanding of some of the innovative features unique to the present invention. The present invention is not intended to be limited by this summary.

The present invention relates to a method and device for removing print material from build plates for 3D printing systems and, more particularly, to the use of flexible material to cover or replace build plates for 3D printers.

A preferred embodiment of the present invention includes a flexible sheet sized to fit atop the build plate of a 3D printer and sized to receive a 3D print wherein the flexible sheet is made from a material, such as polycarbonate, that may be repeatedly flexed and straightened without fracturing or losing its flat disposition. In a preferred embodiment, the flexible sheet is removably placed on top of the build plate for a 3D printer in a manner that restricts movement of the flexible sheet to ensure the 3D print is accurately completed. Upon completion of the printing process, the flexible sheet and the 3D print are removed from the build plate of the 3D printer and the sheet is flexed to allow the 3D print to be removed from the sheet. In a preferred embodiment, the top surface of the flexible sheet is textured for temporary bonding of the first layer of a 3D print to the flexible sheet so that the 3D print does not move or curl away from the sheet during the printing process.

The present invention advantageously allows the user of a 3D printer to easily and cleanly remove print material from a build plate by simply flexing the sheet, resulting in less damage to 3D prints and to the existing build plate of a 3D printer. It also allows for a more efficient reuse of the 3D printer.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### DESCRIPTION OF DRAWINGS

The accompanying figures are incorporated herein and form a part of the specification for the present invention and further illustrate the present invention:

FIGS. 1 to 6 show perspective views of an exemplary embodiment of the present invention, namely a flexible sheet placed on a build plate for a 3D printer.

FIGS. 7 to 11 show perspective views of an exemplary embodiment of the present invention, namely a flexible sheet with a frame placed on a build plate for a 3D printer.

FIGS. 12 to 16 show perspective views of an exemplary embodiment of the present invention, namely a flexible sheet with a support corners placed on a build plate for a 3D printer.

### DETAILED DESCRIPTION OF INVENTION

The present invention is best understood by reference to the drawings and description set forth herein. Embodiments of the invention are discussed below with reference to the drawings. However, those skilled in the art will readily appreciate that the detailed description given herein with respect to the drawings is for explanatory purposes as the invention extends beyond the limited embodiments described. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention.

The present invention should not be limited to the particular embodiment, methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means. Also, singular words should be read as plural and vice versa and masculine as feminine and vice versa, where appropriate, and alternative embodiments do not necessarily imply that the two are mutually exclusive.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number for a claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations. However, the use of such phrases should not be construed to imply a claim recitation by the indefinite articles “a” or “an” limits any particular claim containing such claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of claim recitations is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

Throughout this disclosure, examples will be provided for using the device and method of the present invention. However, those of skill in the art will appreciate additional applications for the disclosed device and method.

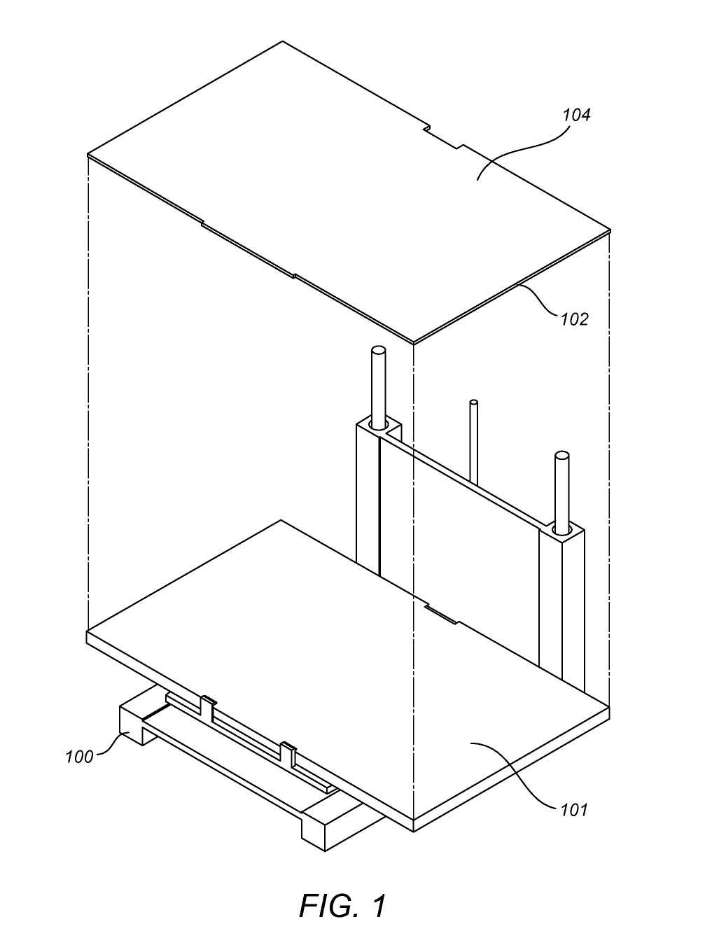

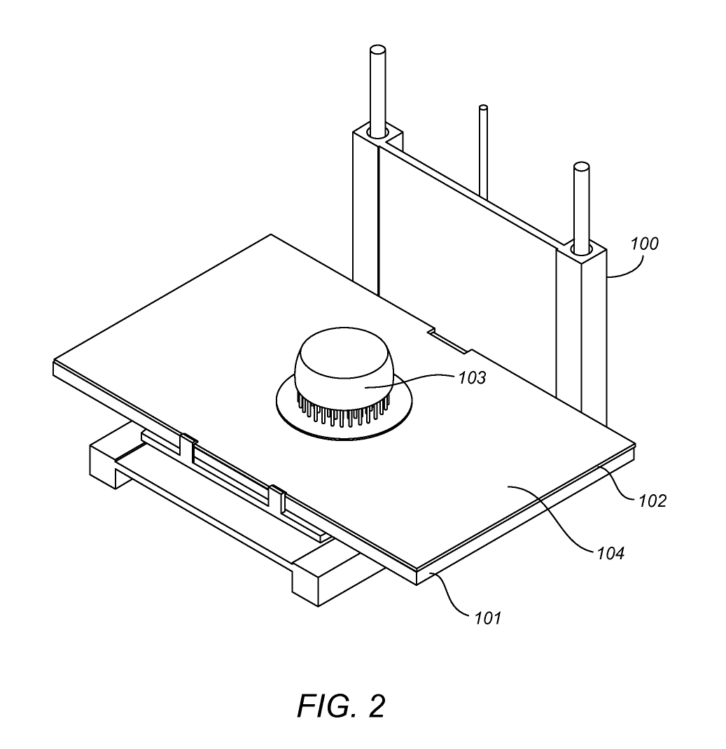

An embodiment of the present invention is provided in FIGS. 1 to 6 and includes a 3D printer 100 with a build plate 101. A substantially flat sheet 102 of flexible material is sized to place atop the build plate 101 of the 3D printer 100 to receive print material and allow a 3D print 103 to be formed on its top surface 104. The sheet 102 is sized and shaped to limit movement of the sheet 102 on the build plate 101 during the printing process and to receive and hold deposits of print material from the 3D printer 100. The sheet 102 is removable from the build plate 101 to allow for the sheet 102 and the 3D print 103 to be lifted from the build plate 101 upon completion of the print.

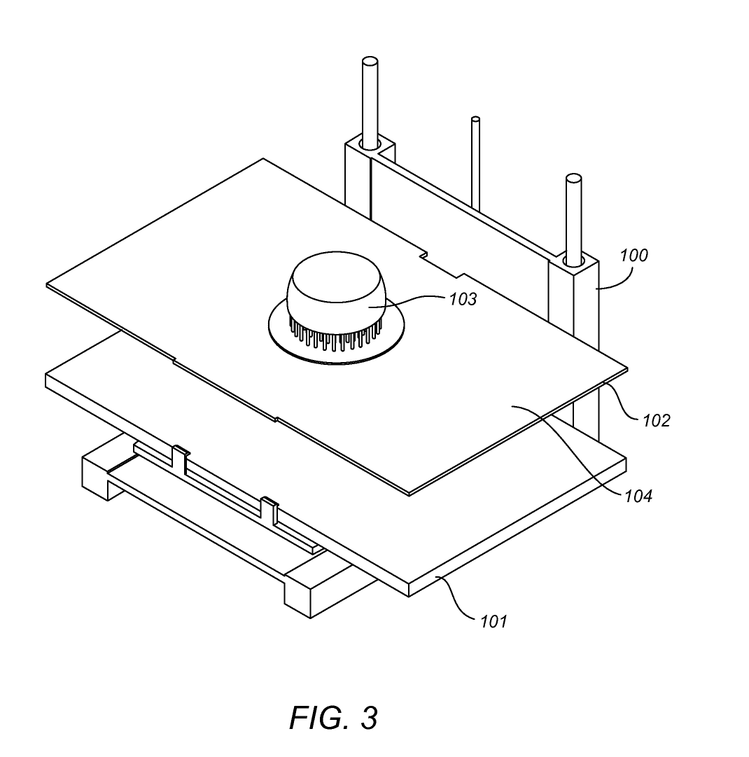

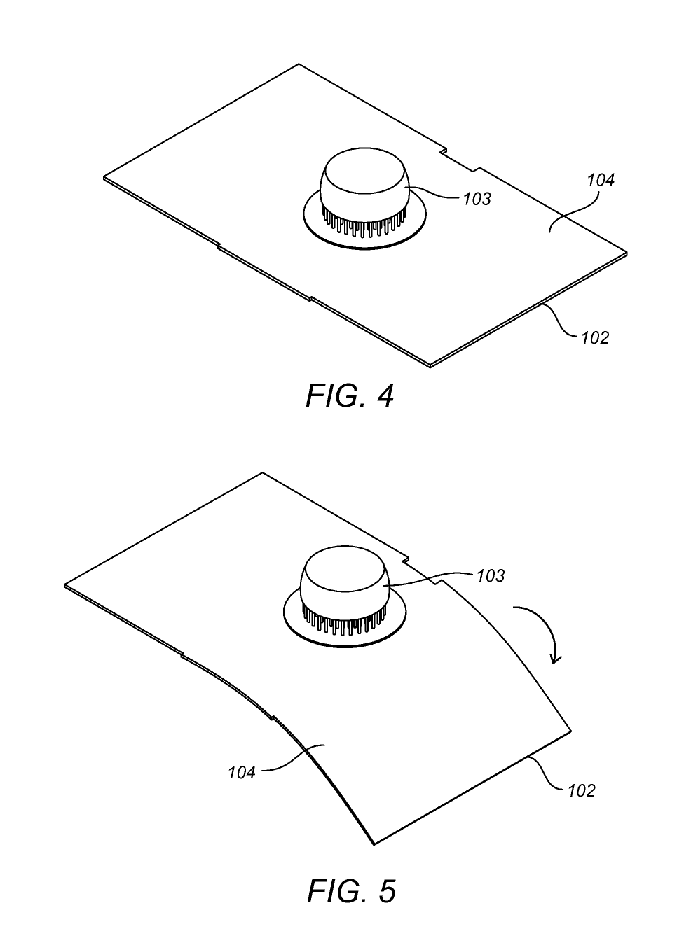

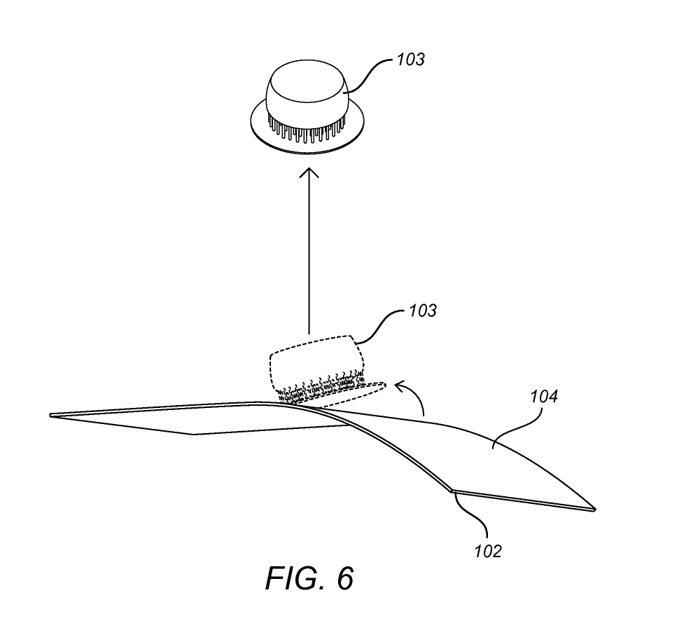

As shown in FIGS. 3 and 4, after formation of a 3D print 103, a user may lift the sheet 102 and the 3D print 103 from the build plate 101 so that the sheet 102 is generally horizontal and immediately below the 3D print 103. As illustrated in FIGS. 5 and 6, the sheet 102 may be flexed along its horizontal axis so that at least one edge of the 3D print 103 pulls away from the sheet 102. Once an edge of the 3D print 103 is exposed, a user may further flex the sheet 102 to remove the 3D print from the flexible sheet 102.

In a preferred embodiment, the sheet 102 is shaped to the build plate 101 of the particular 3D printer 100. Such a shape assists in placement of the sheet 102 and limits movement of the sheet 102 during the printing process. However, other sizes and shapes of the sheet 102 may be used, including rectangular, square, circular, and any other shape that may be used with a build plate 101 for a 3D printer 100. In a preferred embodiment, the sheet 102 is sized to be substantially larger than the desired 3D print 103 to allow the sheet 102 to receive the print 103 and allow the sheet 102 to be flexed sufficiently to remove the 3D print 103 upon completion.

In a preferred embodiment, the sheet 102 is made of a flexible polycarbonate material that may be repeatedly flexed and straightened without fracturing or losing its flat disposition. Other materials with similar qualities may be used, including plasticized materials, metals, graphite, and rubbers.

In a preferred embodiment, the sheet 102 has a thickness of approximately ¼ inch to allow for ease of placing the sheet 102 atop a build plate 101 of a 3D printer 100 and for ease of removing the sheet 102 and the 3D print 103 from the build plate 101 upon completion of the print. Other thicknesses may be used as well, provided the material remains sufficiently flexible to remove the 3D print 103.

In a preferred embodiment, the top surface 104 of the sheet 102 is textured so that a 3D print 103 does not bond permanently to the surface 104 of the sheet 102 for ease in removing the 3D print 103 from the surface 104 of the sheet 102. The textured surface 104 of the sheet 102 also allows for sufficient bonding of the first layer of print material to the textured surface 104 of the sheet 102 so that the 3D print 103 remains in the desired location during the printing process and does not separate prematurely or curl from the sheet 102 placed on the build plate 101.

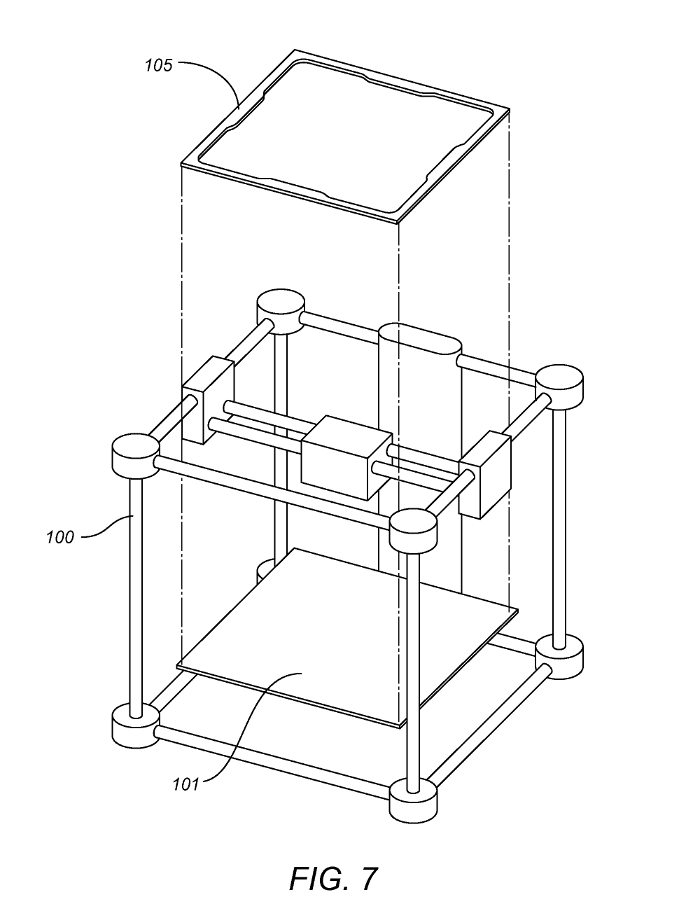

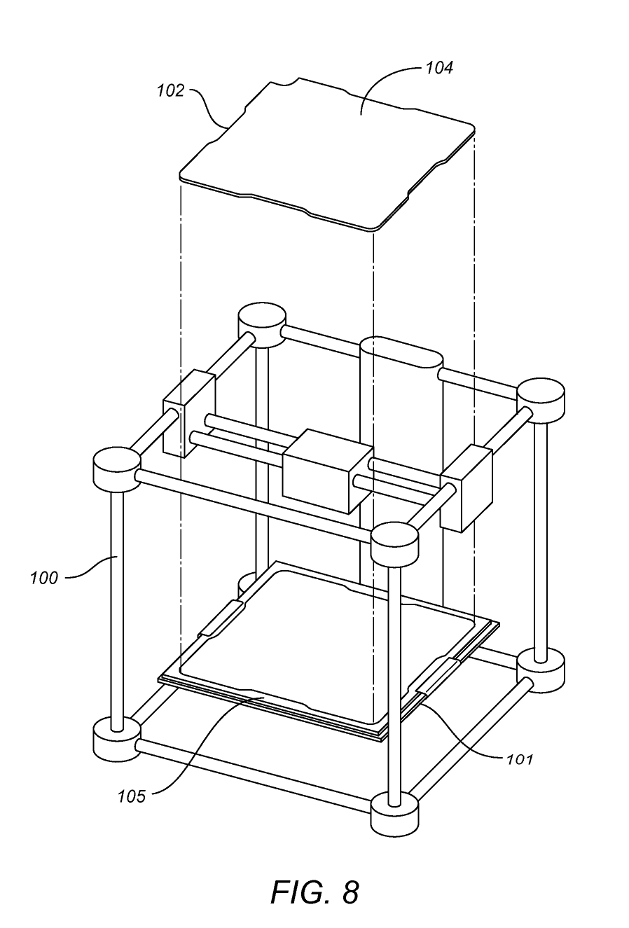

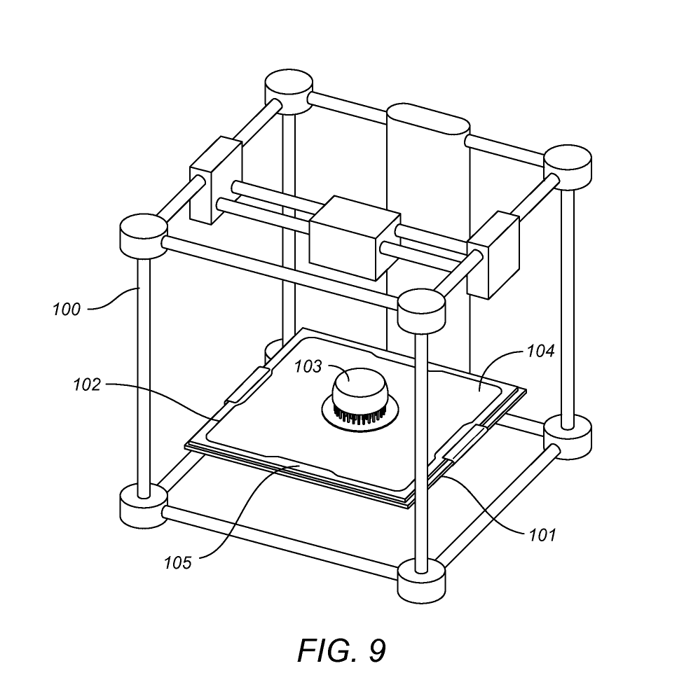

Another embodiment of the present invention is provided in FIGS. 7 to 11, which show a standard 3D printer 100 with a build plate 101. A frame 105 is removably attached to the top surface of the build plate 101. A substantially flat sheet 102 of flexible material is sized to fit within the frame 105 and also placed atop the build plate 101 of the 3D printer 100 to receive print material and allow a 3D print 103 to be formed on its top surface 104. The frame 105 assists in placing and replacing the sheet 102 in a proper location on the build plate 101 and helps ensure that the sheet 102 remains in the proper location during the printing process. The frame 105 further assists in removing the sheet 102 from the build plate 101 upon completion of the print.

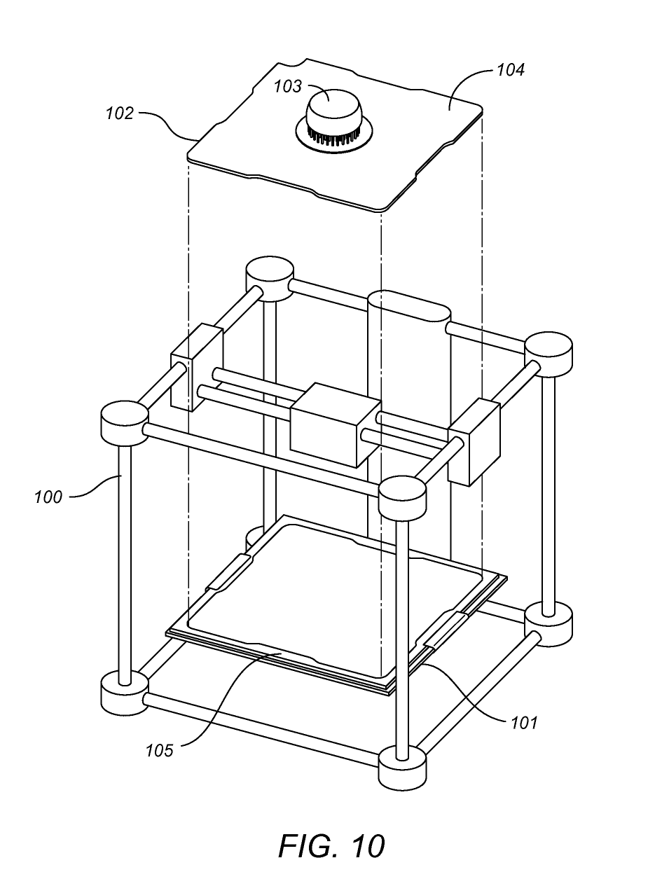

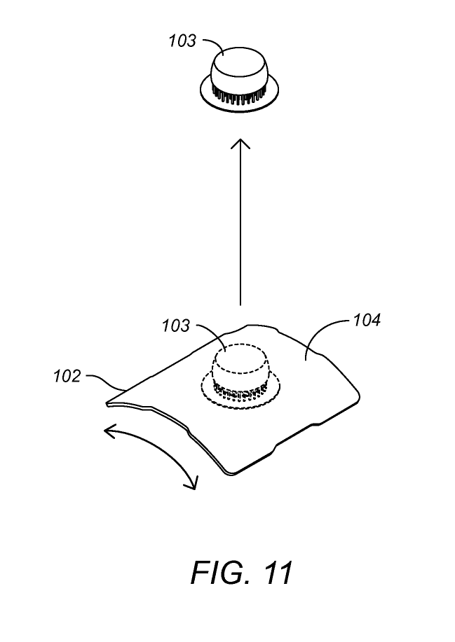

As shown in FIGS. 10 and 11, after formation of a 3D print 103, a user may lift the flexible sheet 102 and the 3D print 103 from the build plate 101 so that frame 105 remains in place on the build plate 101. The sheet 102 is held in a generally horizontal position, immediately below the 3D print 103. As illustrated in FIG. 11, the sheet 102 may be flexed along its horizontal axis so that the 3D print 103 may be removed from the sheet 102.

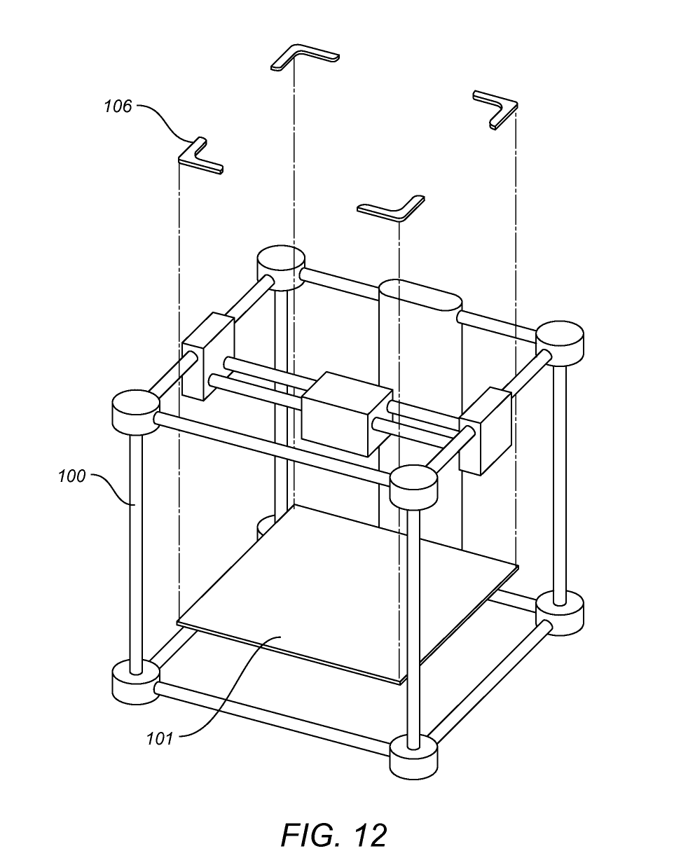

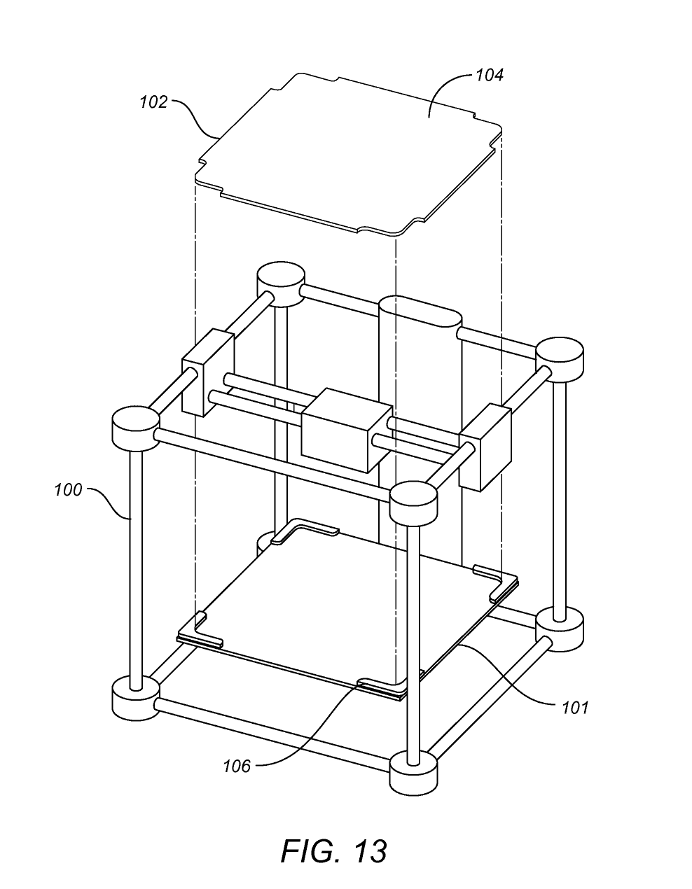

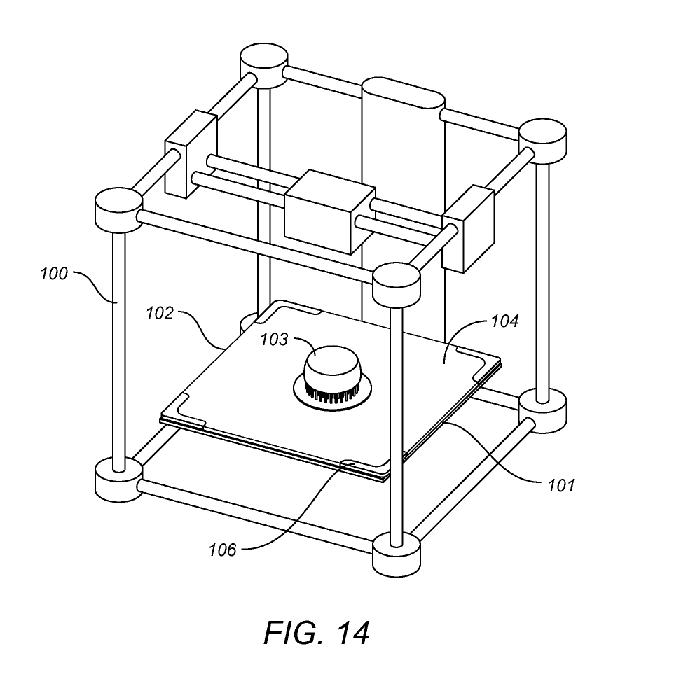

Another embodiment of the present invention is provided in FIGS. 12 to 16, which show a standard 3D printer 100 with a build plate 101. Support corners 106 are removably attached to the top surface of the build plate 101. A substantially flat sheet 102 of flexible material is sized to fit within the support corners 106 and also placed atop the build plate 101 of the 3D printer 100 to receive print material and allow a 3D print 103 to be formed on its top surface 104. The support corners 106 assist in placing and replacing the sheet 102 in a proper location on the build plate 101 and help ensure that the sheet 102 remains in the proper location during the printing process. The support corners 106 further assist in removing the sheet 102 from the build plate 101 upon completion of the print.

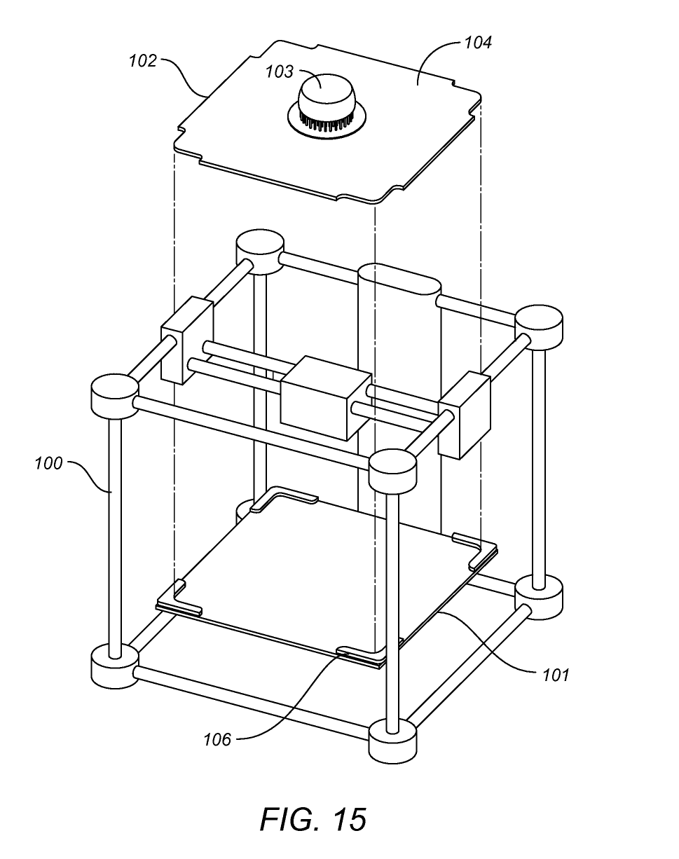

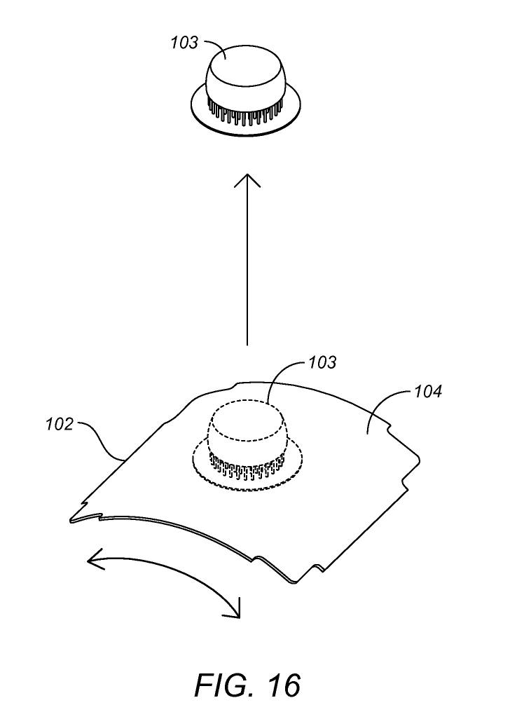

As shown in FIGS. 15 and 16, after formation of a 3D print 103, a user may lift the flexible sheet 102 and the 3D print 103 from the build plate 101 so that support corners 106 remain in place on the build plate 101. The sheet 102 is held in a generally horizontal position, immediately below the 3D print 103. As illustrated in FIG. 16, the sheet 102 may be flexed along its horizontal axis so that the 3D print 103 may be removed from the sheet 102.

The embodiments described in the drawings involve placing a flexible sheet 102 on top of the build plate 101 for a 3D printer. An alternative embodiment of the present invention would be using a removable build plate 101 that is made from a flexible material that would allow a 3D print 103 to be removed by flexing the build plate 101.

An embodiment of a method for using the present invention may include the following steps as revealed in FIGS. 1-16:
a 3D printer 100 with a build plate 101;
sizing a thin sheet 102 of flexible material, such as a polycarbonate sheet, to fit atop the build plate 101 of the 3D printer 100 whereby the flexible sheet 102 is sufficient in size to receive print material from the 3D printer 100 and whereby the sheet 102 has a textured top surface 104 for receiving print material from the 3D printer;
placing the sheet 102 of flexible material on the build plate 101 of the 3D printer 100;
creating a 3D print 103 on the textured top surface 104 of the flexible sheet 102;
after the 3D print 103 is completed, removing the flexible sheet 102 from the build plate 101 of the 3D printer 100;
holding the flexible sheet 102 so that it is generally horizontal and immediately below the 3D print 103;
removing the 3D print 103 by flexing the sheet 102 along its horizontal axis so that an edge of the 3D print 103 pulls away from the sheet 102; and using the exposed edge of the 3D print 103 to remove the 3D print 103 from the sheet 102.

It should be understood, of course, that the foregoing relates to exemplary embodiments of the invention and that modifications may be made without departing from the spirit and scope of the invention as set forth in the following claims.

1. A device for removing a 3D print from a build plate of a 3D printer comprising
a substantially flat sheet of flexible material of sufficient size to receive and hold deposits of print material from the 3D printer, wherein the sheet of flexible material accommodates repeated flexing without fracturing and without loss of the substantially flat disposition, is removably placed atop the build plate of the 3D printer prior to the printing process, and has a top surface that is textured to prevent the 3D print from moving on the sheet of flexible material during the printing process; and
a means for preventing movement of the sheet while atop the build plate of the 3D printer and during the printing process.

2. A device of claim 1 wherein the means for preventing movement of the sheet while atop the build plate of 3D printer during the printing process is a frame removably affixed to the build plate wherein the frame is sized to receive said sheet.

3. A device of claim 1 wherein the means for preventing movement of the sheet while atop the build plate of 3D printer during the printing process is a plurality of support corners removably affixed to the build plate to receive said sheet.

4. A device of claim 1 wherein the flexible material is polycarbonate.

5. A device of claim 1 wherein the flexible material is one of plastic, graphite, or metal.

6. A method for removing a 3D print from a build plate of a 3D printer comprising:
a 3D printer with a build plate;
a substantially flat sheet of material of sufficient size to receive and hold deposits of print material from the 3D printer;
the substantially flat sheet of material is flexible to accommodate repeated flexing without fracturing and without loss of the substantially flat disposition;
the substantially flat sheet of material has a top surface that is textured to prevent print material from moving on the sheet during the printing process;
sizing the sheet to fit atop the build plate of the 3D printer;
removably placing the sheet on the build plate of the 3D printer so that the sheet does not move on the build plate during the printing process;
creating a 3D print on the textured top surface of the sheet;
after the 3D print is completed, removing the sheet and the 3D print from the build plate of the 3D printer;
holding the sheet so that it is generally horizontal and immediately below the 3D print;
removing the 3D print from the sheet by flexing the sheet along its horizontal axis so that an edge of the 3D print pulls away from the sheet; and
using the exposed edge of the 3D print to remove the 3D print from the sheet.

7. A device for removing a 3D print from a build plate of a 3D printer comprising
a substantially flat sheet of flexible material of sufficient size to receive and hold deposits of print material from the 3D printer, wherein the sheet of flexible material accommodates repeated flexing without fracturing and without loss of the substantially flat disposition, and wherein the sheet of flexible material is removably placed atop the build plate of the 3D printer prior to the printing process; and
a means for preventing movement of the sheet while atop the build plate of the 3D printer and during the printing process.

8. A device of claim 7 wherein the sheet of flexible material has a top surface that is textured to reduce movement of the 3D print during the printing process.

9. A device of claim 7 wherein the means for preventing movement of the sheet while atop the build plate of 3D printer during the printing process is a frame removably affixed to the build plate wherein the frame is sized to receive said sheet.

10. A device of claim 7 wherein the means for preventing movement of the sheet while atop the build plate of 3D printer during the printing process is a plurality of support corners removably affixed to the build plate to receive said sheet.

11. A device of claim 7 wherein the flexible material is polycarbonate.

12. A device of claim 1 wherein the flexible material is one of plastic, graphite, or metal.

13. A method for removing a 3D print from a build plate of a 3D printer comprising:
a 3D printer with a build plate;
a substantially flat sheet of material of sufficient size to receive and hold deposits of print material from the 3D printer, wherein the substantially flat sheet of material is flexible to accommodate repeated flexing without fracturing and without loss of the substantially flat disposition;
sizing the sheet to fit atop the build plate of the 3D printer;
removably placing the sheet on the build plate of the 3D printer so that the sheet does not move on the build plate during the printing process;
creating a 3D print on the top surface of the sheet;
after the 3D print is completed, removing the sheet and the 3D print from the build plate of the 3D printer;
holding the sheet so that it is generally horizontal and immediately below the 3D print;
removing the 3D print from the sheet by flexing the sheet along its horizontal axis so that an edge of the 3D print pulls away from the sheet; and
using the exposed edge of the 3D print to remove the 3D print from the sheet.
